(19) United States
(12) Patent Application Publication
(10) Pub. No.: US 2004/0096811 A1
(43) Pub. Date: May 20, 2004

(54) Computer-assisted system for designing training programs

(76) Inventors: Rajesh Shanmukha Anneswamy, Versoix (CH); Ian Green, Nyon (CH); Sanmugan Mahendren, Bernex (CH)

Correspondence Address: STURM & FIX LLP, 206 SIXTH AVENUE, SUITE 1213, DES MOINES, IA, 50309-4076, US

(21) Appl. No.: 10/698,105

(22) Filed: Oct. 31, 2003

Related U.S. Application Data
(63) Continuation of application No. PCT/IB01/00751, filed on May 1, 2001.

(51) Int. Cl. G09B 25/00

(52) U.S. Cl. 434/365

(57) ABSTRACT

A computer-assisted system for production and management of training/learning programs for individuals/groups with a view to achieving learning outcomes by implementing learning objects (LO), comprises a learning object analysis and description standardisation unit (A, B), an outcome standardisation unit (C), an outcome optimization module (F) and a curriculum selection module (G). The LO standardisation unit (A, B) comprises a database of normalised LO parameters (14), a database of normalised LO outcomes (15), and means (10, 12) for inputting LO parameters and converting them into normalised LO outcomes (15). An outcome standardisation module (C) has an input for enterprise outcome parameters (16) and compares these with standardised outcomes comes from an outcomes thesaurus (13) for conversion into standardised/verified enterprise outcome parameters (18). The outcome optimization module (F) receives the standardised/verified enterprise outcome parameters (18) and the normalised LO parameters (14), selectable into different combinations to produce a set of learning curricula (19). The curriculum selection module (G) receives these curricula (19), normalised LO outcomes (15) and normalised enterprise parameters (21) and provides an interactive indicia of the match to requirements of any given learning curriculum selectable by choice of the normalised LO outcome(s) (18) and the verified enterprise outcome(s) (18), for ranking the curricula to select a training/learning plan.

### FIELD OF THE INVENTION

The invention relates to a computer-assisted system enabling the training/learning function of an enterprise to produce training/learning programs, using off-the-shelf and bespoke training/learning products and services. It is particularly concerned with a computer-assisted system for assisting the production, planning, control, tracking and other management aspects of training/learning programs for individuals or groups of individuals of an enterprise, with a view to the individuals(s) achieving learning outcomes by implementing learning objects.

### BACKGROUND OF THE INVENTION

For convenience, various terms used herein are defined as follows:

“Learning Objects” (LO or LO's): courses, tests, exercises, simulations, classroom sessions, tutorial sessions, manuals, games, props etc., all in electronic, paper or material form.

“Description Model”: an example of a standard description of a LO.

“Outcomes”: the learning program and LO objectives expressed in term of what students can do after having taken the learning program/LO.

“Outcomes Thesaurus”: a set of normalised outcome names, synonyms and descriptions.

“Parameters”: elements which define a training/learning program or LO, e.g. cost, duration, number of students, schedule, location, facilities, type of instruction, etc.

“Parameter Model”: an example of a standard set of Enterprise/LO parameters.

“Learning Curriculum”: an organized list of learning activities put together for a target audience to reach a set of capabilities that will support business/enterprise outcomes. In other words, a curriculum is a set of learning objects that are necessary to bring set of outcomes to a student. Normally a curriculum does not include two LO's that are equivalent, i.e. that are associated to the same set of outcomes.

“Pre-requisite” is a set of outcomes that must be acquired by a student before he takes a given LO. The set of LO's in a curriculum is not necessarily a set linked through pre-requisites.

“Enterprise”: commercial undertaking or other organization that employs persons to carry out tasks.

“Students”: an enterprise's staff, partners and/or customers.

When an enterprise's training department organizes a training program, it is usually in response to an explicit or implicit requirement/need of the organization. The inputs that will be taken into consideration are basically a description of expected outcomes, a target audience, and constraints. The expected outcomes can be given in terms of business requirements, which will have to be translated in capability requirements and identification of a target audience, or directly in capability requirements. The target audience are the people involved in achieving the above business requirements. The constraints include time, budget and other constraints, e.g. environmental, infrastructure, policy, practice, etc.

Based on the above inputs, the training/program manager will have to define the best ways to achieve the acquisition of the capabilities necessary to achieve the work required to reach the expected outcomes, within the given time, budgetary and other constraints.

The required capabilities translate into the potential learning objectives for the target audience. Each learning objective can be reached by a learning activity, or “Learning Object” (LO), or a set thereof.

Organized lists of learning activities each put together for a target audience to reach a set of capabilities that will support business outcomes constitute a set of learning curricula, and a training program will use the curricula within a set of managed processes, where time and other constraints are taken into account.

The reason of being of a training program is to increase workers efficiency at work. When an organization launches a training program, it is to support specific enterprise objectives, which are expressed in terms of desired outcomes. The purpose of this step is to define the end goal, which will also be used to apply measurements of success.

The definition of the business objectives is usually given as an input to the training department, as well as the target audience.

For the target audience, in organizational terms it makes sense to first look for people having the closest possible capabilities already available, and see how to bring them together to achieve the bespoke business objectives, before defining training curricula and programs. But this decision is an organizational decision, not a training department decision. It is assumed that people capabilities and availability criteria are not met in the target audience, which is why the training program has got justification.

The desired business outcomes are often specified in the training program request. If they are—and even more if they are not—it is necessary for the training program manager to make sure that these objectives are clear, and to reformulate them in normalised terms, so that they can be translated into “desired workforce capability outcomes”. This will lead to the next phase, defining and prioritizing the set of learning objectives that will help define the content of the program.

A curriculum is composed of a set of LO's and a set of outcomes; more generally, however, a curriculum can be built from LO's only, outcomes only or selection of sets of LO's and outcomes.

The input for building a curriculum is a set of outcomes and/or a list of LO. The output is an ordered set of LO's (=curriculum) with associated outcomes and an indication, if applicable, of the “coverage”.

To complete a training project within a training program, the training manager needs to attach students and parameters to a curriculum. First the curriculum manager selects one or more than one group of students and attaches it to a curriculum.

To build a curriculum, it is necessary to understand the starting point, so the learning curriculum can be derived from a good representation of current state and desired future state.

A basic curriculum is built on the basis of fundamental assumptions about the target audience capabilities. This first requires an assessment of the capabilities the target audience should have. From this, a distinction is drawn between the capabilities from the “should have” list, which the target audience already has, and the capabilities from the “should have” list which the target audience does not have, and needs to acquire.

The assumptions can be checked or replaced by a Training Needs Analysis.

As a result, the program outcomes can be defined in terms of capabilities to acquire, i.e. learning objectives. We now know, not only where we want to go (the desired future state), but also where we come from (the current state), and get ready to define a road map to get there.

The next step will be the definition of the learning curricula.

Each capability to develop is a potential learning objective for the target audience.

Each learning objective can be reached by a learning activity, or “Learning Object” (LO), or a set thereof.

The organized list of learning activities put together for a target audience to reach a set of capabilities that will support enterprise goals (desired outcomes) constitute a learning curriculum.

For better efficiency of the training program, the curricula will ideally be customized to the personal training needs of the target audience members, as per the result of the training needs analysis, or based on personal assessment. This can lead to a number of personal curricula, all based on a starting standard curriculum with some additions or subtractions.

As each learning objective can be reached by a learning activity, or a “Learning Object” (LO), or a set thereof, the training program manager needs to identify the possible “solutions” to a capability acquisition problem, within what is available in the various sources he has access to.

The potential LO can be in any format: in-house courses, external courses, online courses, instructor-led, books, tapes, etc.

The challenge for the curriculum designer will be to make a right and coherent choice within a rich learning solutions offer, or to find solutions where there are none or not many available at a cost that would be supported by the available budget, and following modalities that will support the time constraints, while reaching the necessary quality in terms of learning.

As stated above an organized list of learning activities, put together for a target audience, to reach a set of capabilities that will support business outcomes constitute a learning curriculum.

Producing a learning curriculum is a recurrent process, starting first with a theoretical, standard, basic curriculum, that will need to be refined, and involves difficulties in particular because all LO do not have the same relevance: the target audience may not need all of them, since the objectives could already be acquired; some of the LO could be complementary, or prerequisites to others; some would address very critical capabilities; and some could be mandatory, some optional etc . . .

All of these difficulties need to be managed. In fact, the production of training/learning programs for individuals or groups of individuals of an enterprise is highly complex and increasingly work-intensive as the size of the enterprise increases together with the number of individuals/groups having different training needs, taking into account also the variety of available learning objects and budget, time/timing and other constraints.

Reduced training costs and improving staff performance continue to be a high priority for enterprises. There is an increasing demand for on-line services to support the deployment, management and on-going development of skills. There are numerous computerized learning management systems on the market. However, there is a complete lack of integrated systems and tools for managing the production of training/learning programs which are “upstream” of the existing learning systems.

### BACKGROUND ART

There have been many proposals to use computer systems in a training context.

U.S. Pat. No. 5,416,694 is concerned with assessing an individual's acquisition of specifically identified skills and abilities and the relationship of these skills and abilities to an identified occupation, using a computer-based system.

U.S. Pat. No. 5,890,149 relates to an employee training and coaching system in an organization, for disseminating collective knowledge of a body of corporate employees using a computer system.

U.S. Pat. No. 5,904,485 discloses a computer system in which a school curriculum is stored for access by students at home. Appropriate material for presentation to each student during each learning session is selected by an intelligent administrator based on the student's learning profile.

U.S. Pat. No. 6,157,808 describes a computerized employee certification and training system designed to support an efficient management of employee development, by developing training materials, career paths and determining an employee's qualifications and performance. This patent is concerned principally with controlling certifications for an employee to be able to perform a given job.

However, none of the prior patents offers a solution to the problem of optimizing the design and production of a training plan for different target groups based on available learning facilities.

### SUMMARY OF THE INVENTION

The invention aims to facilitate the production of a training plan that fits the needs of any enterprise, making use of available learning objects. It provides a computer-assisted system for the production of training/learning programs for individuals or groups of individuals of an enterprise, with a view to the individuals(s) achieving learning outcomes by implementing learning objects (LO), which considerably automates design/production of the training program and will enable a training manager, once the training needs have been identified, to produce a plan for implementing the training objectives.

The system according to the invention comprises a computer database (hereinafter “database”) of normalised LO parameters wherein LO's are described in the framework of a normalised description; a database of normalised LO outcomes wherein LO outcomes are described in the framework of a normalised description; and a database of learning outcome parameters described in the framework of a normalised description corresponding to that of the normalised LO outcomes.

The system further comprises a curricula generation module or “learning outcome optimization modules” receiving normalised learning outcome parameters and normalised LO parameters, selectable into different combinations thereof for producing a set of alternate learning curricula, each curriculum comprising a set of learning objects that are necessary for the individual(s) to reach a set of outcomes.

A curriculum selection module of the system receives curricula from the outcome optimization module and said normalised LO outcomes, and is arranged to provide an interactive indicia of the match to requirements of any given LO within a learning curriculum selectable by the user choosing LO's corresponding to the normalised LO outcome(s) and learning outcomes corresponding to the learning outcome parameters, to assist ranking the curricula for selection of a training/learning plan.

The computer-assisted system according to the invention makes use of available computer hardware including adequate processing and memory capacity for storage of the computer databases and management software. The system is programmed with available software for example Enterprise JavaBeans™ technology powered by an Oracle™ database. This technology allows the processes to be encapsulated into objects that are flexible, extensible, reusable and can evolve as need be. Using this technology, the main computer system can be stored in a server accessible to the users through an Application Service Provider (ASP) model via a network, in particular the internet.

In one embodiment the system according to the invention comprises a learning object analysis and description standardisation unit, an outcome standardisation unit, an outcome optimization module and a curriculum selection module.

The learning object analysis and description standardisation unit comprises a database of normalised LO parameters wherein LO's are described in the framework of a normalised description, and a database of normalised LO outcomes wherein LO outcomes are described in the framework of a normalised description. Means are provided for inputting LO parameters and for comparing input LO parameters with an LO parameter model, there further being means to assist, prompt or effect the conversion of input LO parameters into normalised LO parameters and normalised LO outcomes manually, semi-manually or automatically.

The outcome standardisation unit comprises an outcomes thesaurus database associated with an outcome standardisation module having an input for enterprise outcomes. The outcomes thesaurus database contains a set of normalised outcome names, synonyms and descriptions. The outcome standardisation module is arranged to compare input enterprise outcomes with standardised outcomes from the outcomes thesaurus database and is associated with an outcome verification module, these modules comprising means to assist, prompt or effect the conversion of input enterprise outcomes into standardised/verified enterprise outcome parameters.

The outcome standardisation unit is arranged to normalise and verify the input enterprise outcomes as follows. Normalisation is needed because the system accepts the outcomes as they are given by the enterprise in non-standard format. First it matches them with normalised outcomes stored in the outcomes thesaurus database when the enterprise outcome parameters are expressed in the same or very similar language to stored normalised outcomes. When however the input enterprise outcomes are expressed in words that are different to stored normalised outcomes, these words are converted into synonyms thereof taken from those stored in the outcomes thesaurus, then matched with normalised outcomes stored in the outcomes thesaurus. If there is a failure to find a satisfactory match with normalised outcomes stored in the outcomes thesaurus, the module provides for a verification to complete the outcome standardisation.

In the latter case if some outcomes have been partly standardised by replacing some words with synonyms but there is still a mismatch, the outcome standardisation unit is arranged to allow a verification that identifies the mismatched partly standardised outcome and ensures that it is grammatically and lexically correct. If correction if necessary, this can be done by manual input. After verification, the new outcome is then proposed as a verified outcome for addition to the outcomes thesaurus, such addition preferably being controlled by the user. In this way, the outcomes thesaurus is constantly enriched with new normalised outcomes.

The outcome optimization module receives standardised/verified enterprise outcome parameters from the outcome verification module and normalised LO parameters from the LO unit, selectable manually, semi-manually or automatically into different combinations thereof to produce a set of alternate learning curricula.

The curriculum selection module receives curricula from the outcome optimization module, normalised LO outcomes from the LO unit, and normalised enterprise parameters that indicate values an enterprise attributes to the normalised LO outcomes, this module providing an interactive indicia of the match to requirements of any given LO within the learning curriculum selectable by choice of the normalised LO outcome(s) and the verified enterprise outcome(s) for ranking the curricula to select a training/learning plan.

The design of the learning plan or program is the organization of the curricula within a set of managed processes, where target audience, budget, time and the other constraints are taken into account. Through the system according to the invention, this program design stage is considerably automated.

Prior art training proposals using computer systems are based principally on a student-centric model. In contrast, the system according to the invention is centred on learning objects and their learning outcomes in the context of the enterprises who need to organize the training. By this management-centric approach, the invention focusses on the enterprise's training manager, surrounded by the curriculum manager, responsible for the preparation of an overall training program in line with the enterprise's budget and objectives, as well as the training administrator responsible for the deployment of the training program, the student himself who takes the training assigned to him, or prepared by him, and the content manager, responsible for the identification and acquisition of the training content.

According to one embodiment, the system of the invention has a Thesaurus of “Business Outcomes”, i.e. learning objectives, linked to learning activities/learning objects (LO).

It will further provide an automatic presentation of potential LO's.

After selection of the learning objectives, the user will automatically get a corresponding basic curriculum.

At this stage, the curriculum is composed of all LO's that cover at least one of the objectives. Some objectives are covered by more than one LO, some LO cover more than one objective.

The user may then optimize the curriculum: 1) with respect of desired outcomes (e.g. to minimize LO redundancy); 2) with respect of the cost and time aspects; and 3) With respect of other parameters such as use of existing facilities or team, internal policies, preferred learning styles.

At the end of the design of a basic curriculum (“Standard curriculum”), the LO can be categorized in mandatory, additional, and optional.

With the system according to the invention, a training manager can:

Build and customize curricula;

Define the size of the target students population;

Define the project's time constraints;

Add to the system's LO database the internal learning modules with their various parameters, such as cost, language, location, calendar, etc.; and

Select the complementary services (e.g. synchronous or asynchronous electronic tutoring and/or conferencing) that will be made available to the students.

The system can automatically provide the user with: a roll-out map; a total budget computation, including a quotation for the components delivered and charged directly by the system provider; and, where required, a proposal for a corresponding service level agreement.

With the system according to the invention, curriculum customization is another instance of curriculum design. Authorisation can be given to an end-user to customize his own curriculum, also on the basis of a standard curriculum that has been assigned to him. The necessary authorisations can be managed with a workflow feature of the system's program.

Once the set of curricula is designed, the training program manager needs to make sure that all LO are actually available in his environment and take into account their delivery conditions. This may need contracting with third parties for instructor-led training (ILT), development or acquisition of online courses, customization, implementation and integration in the learning environment, etc.

It is possible for the system provider to offer a vast catalog of existing LO's from many different suppliers linked to a Thesaurus of business objectives. The client/user can also add his own LO to the suppliers catalog. If the client/user has profession-specific LO's developed himself, he may be offered the choice to share these solutions.

Further features of the invention are set out in the following description and in the claims.

### BRIEF DESCRIPTION OF THE DRAWINGS

In the accompanying schematic drawings:

FIG. 1 is a block diagram of an example of a system according to the invention. Its right-hand part shows the learning object analysis and description standardisation unit. Its left-hand part shows the outcome standardisation unit, the outcome optimization module and the curriculum selection module.

FIG. 2 is a learning outcomes/learning objects matrix.

### DETAILED DESCRIPTION OF THE INVENTION

Table I indicates the process steps A-H carried out in a system according to the invention, with their corresponding inputs and outputs.

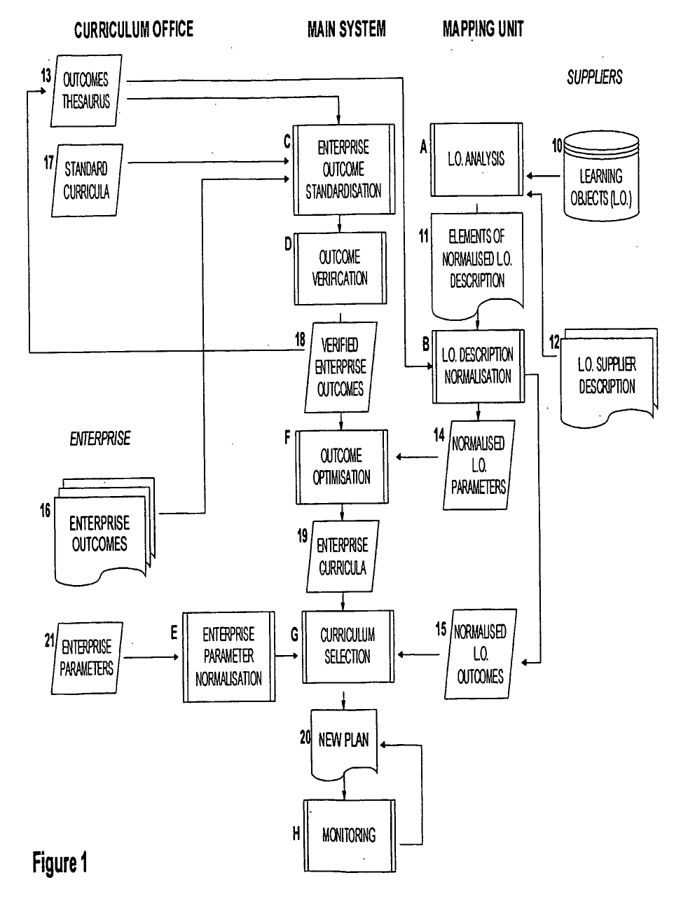

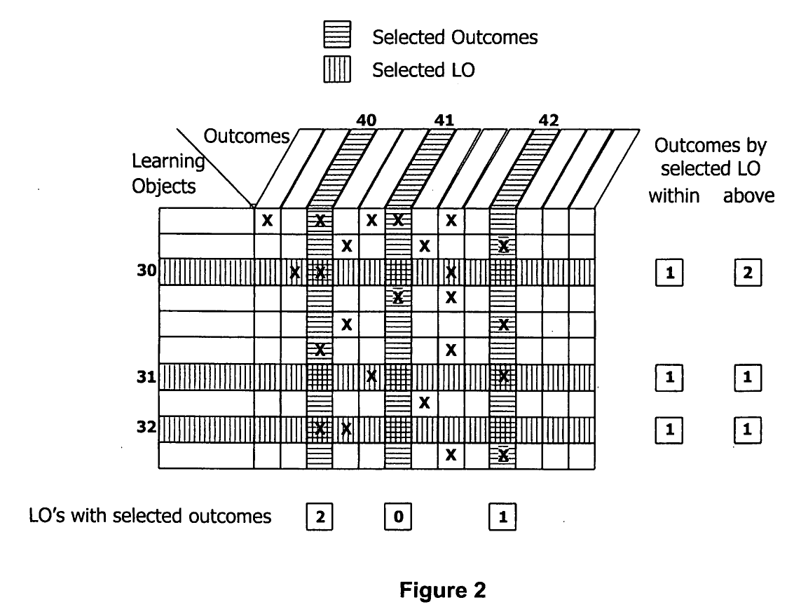

FIGS. 1-2 show the layout of a system according to the invention including modules A to H which correspond to the respective process steps A to H in Table 1. These Figures show the computer system split according to its principal functions, also showing its interaction with data from Suppliers via a Mapping Unit and a Curriculum Office (of the system manager), and from Enterprises (the users).

TABLE I

| Inputs | Processes | | Outputs |
|---|---|---|---|
| Learning | A. | LO Analysis | Elements of |
| Objects (LO) | | | normalised LO |
| Description Model | | | description |
| Elements of | B. | LO Description | Normalised LO |
| normalised LO | | Normalization | outcomes |
| description | | | Normalised LO |
| LO supplier | | | parameters |
| descriptions | | | |
| Outcomes Thesaurus | | | |
| Parameter Model | | | |
| Enterprise outcomes | C. | Enterprise | Normalised |
| | | Outcome | enterprise |
| Outcomes thesaurus | | Standardisation | outcomes |
| Normalised enterprise | D. | Outcome | Verified |
| outcomes (desired) | | Verification | Enterprise |
| | | | outcomes |
| Enterprise | E. | Enterprise | Normalised |
| parameters | | Parameter | enterprise |
| Parameter model | | Normalization | parameters |
| Verified Enterprise | F. | Outcome | Enterprise |
| outcomes (desired) | | Optimization | curricula |
| Normalised LO | | | |
| outcomes | | | |
| Normalised enterprise | G. | Curriculum | Enterprise |
| parameters | | Selection | training/ |
| | | | learning plan |
| Normalised LO | | | |
| parameters | | | |
| Enterprise | | | |
| curricula | | | |
| Enterprise | H. | Monitoring | Monitoring |
| training/learning | | report | |
| plan | | | |
| | | | New plan |

Modules A and B are conveniently located in a mapping unit of the system manager. Here, processes A (LO Analysis) and B (LO Description Normalization) are undertaken for all LO's whose descriptions are to be loaded into the description database. The mapping unit, who will also generate and add to the data for an Outcomes Thesaurus 13, undertakes this activity manually, or with computer assistance.

Learning Objects 10 from a multiple suppliers, including the enterprise for which the training/learning program is being designed, are described in a normalised way using the processes A and B specified in Table 1. This takes place in the LO Analysis Module A and LO Description Normalization Module B shown in FIG. 1.

Module A provides normalised descriptions, referred to as “elements of normalised LO description” 11 which are supplied to module B which stores a Parameter Model database. The module B also receives an LO Supplier Description 12 and data from the Outcomes Thesaurus 13, and provides two outputs: normalised LO parameters 14 and normalised LO outcomes 15, which provide input to modules F and G, as described below.

In module A, LO supplier descriptions are examined to see if they contain all the necessary elements for normalizing, using a Description Model. If they do, the normalised elements of LO description are taken from the supplier description and entered into a normalised format as required by module A. If they do not, the LO's 10 are examined, the necessary elements to normalise the descriptions are identified and corresponding entries made into module A's normalised format.

In module B, elements of LO supplier descriptions 12 and, if necessary, elements of standard LO description 11 from module A, are normalised using a Description Model, data from the Outcomes Thesaurus 13 and the Parameter Model database stored in module B. The descriptions established in module B are loaded into a description database of module B for output as normalised LO parameters 14 and normalised LO outcomes 15.

Similarly, outcomes and parameters are also described in a normalised way, using processes C and E respectively in an Enterprise Outcome Standardisation Module C and an Enterprise Parameter Normalization Module D.

In module C, Enterprise Outcomes 16 are systematically compared one by one with normalised outcome names, synonyms and descriptions contained in the Outcomes Thesaurus 13. The Enterprise Outcomes 16 represent outcomes of any given training program, as defined by the enterprise, conforming to whatever model the enterprise uses, e.g. competency model. The level at which the outcome is expected, and the environment within which it is exhibited, are also taken into account. Equivalences are established, and each enterprise outcome is mapped to an outcome name or synonym in the Thesaurus. This activity is undertaken by someone familiar with the enterprise outcomes 16 using a programmed normalization module.

The enterprise will also have the option of using a standard curriculum from a collection of Standard Curricula 17, in which case the normalization will have already been completed, or of modifying a standard curriculum, in which case only the modifications will be normalised.

Module C provides normalised enterprise outcomes which are verified in the outcome verification module D. Each mapping is verified for consistency and coherence—exceptions are identified automatically, and a specialist decides how they will be treated. In the case where an enterprise outcome has not been successfully mapped, a new outcome or synonym is manually created. From these manually-adjusted inputs, a set of verified enterprise outcomes 18 is created automatically, using normalised language, for each training/learning program, the new verified outcomes 18 being sent to the outcomes thesaurus 13 for addition thereto.

These normalised/verified enterprise outcomes 18 and normalised LO parameters 14 are then matched or “optimized” by process F to produce a choice of training/learning programs (each constituting a “curriculum”) for a group of students, viz. Enterprise Curricula 19. These curricula 19 are then ranked by process G in Curriculum Selection Module G according to enterprise parameters 21 to produce a single chosen curriculum, the enterprise training/learning plan 20.

In outcome optimization module F, using both the verified enterprise outcomes 18 and the LO outcomes (normalised LO parameters 14), a set of alternate curricula 19 are established, with a specialist from the enterprise (the “curriculum manager”) making choices on how best to achieve the optimization, the computer system carrying out these choices.

An enterprise parameter normalization module E is provided which inputs enterprise parameters 21 and outputs normalised enterprise parameters. The enterprise parameters 21 are provided by the enterprise, indicating which values it gives for each training/learning program to the standard parameters contained in the Parameter Model. These are verified automatically.

Curriculum selection takes place in module G, which inputs normalised enterprise parameters from module E and normalised LO outcomes 15 from module B. In module G, chosen curricula 19 from module 18 are ranked according to, firstly, the values given to the standard parameters and secondly, the weightings given to each parameter. The computer system presents to the curriculum manager a description of each of the outcomes and each of the LO's being optimized, selectable by the curriculum manager individually and in combinations, and provides the curriculum manager inter alia with an indicia of the match to requirements of a given curriculum through interactive indices, for example through these five interactive indices:

1) percentage of enterprise outcomes which are covered by selected LO's;

2) percentage of LO outcomes which are in excess of enterprise outcomes;

3) desired cost versus actual cost;

4) desired duration versus actual duration; and

5) desired mix of training/learning methodologies versus actual mix.

These indices change as the curriculum manager adds and subtracts LO's from the normalised LO outcomes 15 and adds and subtracts enterprise outcomes from 18. At the end of this process, the curriculum manager chooses a set of curricula 19.

The curriculum manager can thus interactively modify both the values and the weightings of relative importance of the parameters, and have the results presented to him on a computer screen or in a printed report. Parameters which can be expressed in relative terms (cost, duration, mix of training/learning methodologies) are presented interactively on the screen. When the curriculum manager decides that the optimum has been reached, a plan is automatically produced, on screen and/or by print-out. To the extent to which schedules and locations have been selected as parameters, the plan includes scheduling information.

The implementation of the training program needs to be managed and followed-up to ensure success. This phase comprises mainly: curriculum assignment to the target audience; orientation of participants; monitoring and support of learners activities; planning of instructor-led sessions and participants enrollment; and follow-up costs. Principally, outcomes need to be measured and compared with the original objectives, to measure the efficiency of the program. This supposes the ability to measure all costs by category and compare to initial budget, and measure outcomes: did the program reach the goals?

For this, the plan 20 is monitored in an optional module H according to the parameters chosen, periodic reports are produced, and optionally the plan is changed. Using module H, the enterprise can regularly update the parameters selected as the plan is implemented. These are then compared with the parameter values and weightings originally chosen. Periodic reports (such as actual parameters vs. chosen parameters) are produced, a comparative report is automatically generated and if needed a new plan is produced or the existing one amended.

Processes C to H are undertaken for each enterprise training/learning program. In many cases, an enterprise having undertaken C and D for one program will be able to reuse the generated outcomes 18 for other programs.

The system according to the invention is advantageously delivered through an Application Service Provider (ASP) model via the internet. It can be part of a fully-scalable integrated management-centric B2B solution that involves both aggregation of on-line courses and Straight-Through Processing (STP) of training management functions. The system can thus be associated with management tools for sourcing, planning and budgeting the training needs, as well as enterprise training administration and student progress tracking, providing a fully-fledged collaborative e-learning environment for students and a broad spectrum of off-the-shelf content in all knowledge domains (IT, ERP and industry applications, skills and management etc.). Accessed through a tailored enterprise portal, such service will allow integration of enterprise-specific content and non-electronic courses.

In a preferred embodiment, the system content is defined in a Content Description Language (CDL) which allows the definition of company or personal objectives in terms of outcomes. Outcomes are used to normalise the identification of the result that a given training module is expected to achieve. CDL therefore allows to define objectives in generic terms not immediately linked to a given set of training content, to compare alternate training solutions that are expected to achieve similar results and choose the most appropriate with regard to other characteristics (cost, delivery method, etc.), to identify and present the global expected achievement of a set of training solutions and compare with the desired result, and to identify the additional training value of a set of training solutions with regard to the planned objectives.

Managers and students will be able to construct their curriculum through a mixed selection of training solution and identification of desired outcomes. Using the system of the invention, they can optimize the training program or curriculum to match their objectives taking into account other constraints and objectives.

FIG. 2 is a matrix illustrating learning outcomes as they apply to different learning objects. A learning object (LO) is a solution that enables a student to acquire knowledge and skill in order to reach an outcome. A learning object can be of several types: lecture lab, computer-based training, book, test, etc.

Each LO has attributes, including for instance: approval needed from the curriculum manager (yes/no), if yes time range for approval, expressed in days with value from 0 to n; approval needed from the training administrator (yes/no), if yes time range for approval, expressed in days; last cancellation date (expressed in days before the LO start date); feedbacks related to the LO; pre-requisites—a set of outcomes that the student needs to own before registering for the LO; availability dates; for a lecture lab, the maximum number of people, the required number of computers and period, the required room and period, and the trainer/day required.

The purpose of the curriculum builder is to select a set of LO that matches best a set of outcomes, Curricula are built by the curriculum manager, using the system according to the invention, in a global form for groups of students, and by the students themselves. To build a curriculum, the users can select LO's from the catalog of normalised LO parameters 14, select outcomes from the thesaurus 13 (viz. at the outcome optimization module F) and/or select standard curricula 17 offered by the system, and combine and modify these in the curriculum selection module G.

A “good” curriculum must present a high coverage for the selected outcomes; a low coverage of outcomes not selected and a low redundancy in outcomes coverage. This can be achieved manually in the curriculum selection module G. An automatic generation of a curriculum based on a selection of LO's and outcomes is also possible. The curriculum selection module G is designed to present information allowing the user to make intelligent choices, for instance: by being informed of the number of LO that address the same outcome, by being informed of the number of outcomes that are part and above the selected set for a given LO, by providing an overview of the coverage and redundancy of the entire curriculum, and by presenting a list of choices of LO addressing a selected outcome and the impact on the entire curriculum.

A matrix such as that shown in FIG. 2 allows the user a good perception of the quality of the curriculum being built. References 30, 31, 32 indicate selected learning objects and references 40, 41, 42 indicate selected outcomes. As indicated in FIG. 2, the number of outcomes by selected LO is 1-within and 2-above for LO 30; 1-within and 1-above for LO 31; and also 1-within and 1-above for LO 32, whereas the number of LO's per selected outcome is 2 for outcome 40, 0 for outcome 41 and 1 for outcome 42.

The business objectives of an entire training program are set by the training manager. There are essentially three scenarios that drive the preparation of a training program, the competency plan, discrete explicit needs and business objectives. In the competency plan, the purpose of the program is to enhance specific competences within the organization, for example to develop security awareness. The discrete explicit needs approach means that the content of the training plan program is predefined, for example migration program to a new platform. In business objectives, the purpose of the training program is to solve a business problem, for example to reduce help desk response time. As such, the objectives of the training program are expressed in free text associated to the training program.

The invention will be further described by way of an example illustrating normalised LO parameters. Table 2 shows an extract of an LO description, including elements of the Parameter description and the Outcome description. In this example, the LO is an electronic course teaching the use of Lotus™ Notes, supplied by Educational Multimedia Corporation, and the system manager is identified as TrainingFox.

In Table 2, the Parameters are taken from the supplier's description or from the LO itself and inserted into the description. The Outcomes, however, are transformed. This occurs as indicated after the Table.

TABLE 2
TrainingFox Learning Object Description
Learning Object Identification and Use

| | |
|---|---|
| Title: | Lotus Notes R5 - Part 1 |

| | | | | | |
|---|---|---|---|---|---|
| Version: | n/k | Date of Version: | n/k | Status: | Complete |

| | |
|---|---|
| Provider: | Educational Multimedia Corporation |

| | | | |
|---|---|---|---|
| Provider's ID: | None obvious | TrainingFox's ID: | Not assigned |

| | | | |
|---|---|---|---|
| Payment Required for Use: | presumed | Restricted Use: | presumed |

| | |
|---|---|
| Managed By: | Educational Corporation |

| | |
|---|---|
| Type of Learning Object: | Course |
| Learning Object Medium: | CDROM |

| | |
|---|---|
| Meta-Data-Scheme Compliance: | None known |

| Location: | TrainingFox Delivery Server | | |
|---|---|---|---|
| Reviews: | None known | | |
| Language: | American English | Size: | 181 MB |

| T/C | Taxonomy or Catalog | Entries |
|---|---|---|
| | No Separate Taxonomy | Taxonomy defined by Course Modules |

| | |
|---|---|
| Prerequisites: | None stated formally - presumably basic |
| | PC operation |
| Tested by (internal): | Pre-assessment test, questions, and section tests |
| Tested by (external): | None known |

| | | | |
|---|---|---|---|
| Coverage: | Anticipated future Lotus | Difficulty: | 2 |
| | Notes users | | |

| | | | |
|---|---|---|---|
| Duration: | Not relevant | Semantic-Density: | 2 |

| | | | |
|---|---|---|---|
| Interactivity-Level: | 1 | Interactivity-Type: | Mixed |

| | | | |
|---|---|---|---|
| Typical-Age-Range: | None | Typical-Learning-Time: | 1 day |

| | |
|---|---|
| Learning-Context(s): | Vocational Training |

| | |
|---|---|
| Learning Object User Role(s): | To become Lotus Notes R5 user |

Keywords Provided by Provider

None obvious

Usage Conditions and Required Support Resources
Learning-Outcomes asserted by Provider (Top Ten)

| No | Learning Outcome | Type | Level |
|---|---|---|---|
| 1 | Know key components of Lotus Notes R5 | Knowledge | Basic |
| 2 | Know basic functions of Lotus Notes R5 | Knowledge | Basic |
| 3 | Perform basic functions of Lotus Notes R5 | Skill | Basic |
| 4 | | | |
| 5 | | | |
| 6 | | | |
| 7 | | | |
| 8 | | | |
| 9 | | | |
| 10 | | | |

Learning Object Analysis

| | | | Version of | Levels of |
|---|---|---|---|---|
| Analyst | Role | Date | Description | Analysis |
| John Smith-Jones | Independent | 15-Nov-2000 | t1.0 | Course |
| | Analyst | | | |

Analyst's Assertions of Competences

| Competence | Type | Level |
|---|---|---|
| Known basic concepts of Lotus Notes | Knowledge | Basic |
| Elementary operations with Lotus Notes | Skill | Basic |
| Databases | | |
| Elementary operations with Lotus Notes Mail | Skill | Basic |
| Elementary operations with Lotus Notes | Skill | Basic |
| Calendar | | |
| Elementary operations with Lotus Notes | Skill | Basic |
| Address Book | | |
| Elementary operations using Lotus Notes to | Skill | Basic |
| access the World Wide Web | | |

Transformation of Outcomes Takes Place as Follows:

1. A client will establish a desired outcome for example using the following words: “Newly recruited employees will all have mastered those features of Lotus Notes R5 most frequently used, after having received training”.

2. The supplier has described the LO as follows: “At the end of this course, students will be familiar with the most important elements of Lotus Notes R5, will understand the functionality, and will be able to undertake elementary operations”.

3. The Thesaurus will have, inter alia, the following entries:

basic: synonyms=important, frequently . . .

component: synonyms=element, . . .

course: synonyms=training, . . .

function: synonyms=feature, functionality, operation, . . .

know: synonyms=master, understand, familiar, . . .

perform: synonyms=undertake, able, . . .

4. The Thesaurus is used to normalise the supplier's Outcome description as indicated under the caption “Learning-outcomes asserted by Provider (Top Ten)” in Table 2: “Know key components of Lotus Notes R5 Know basic functions of Lotus Notes R5 Perform basic functions of Lotus Notes R5”.

5. The Thesaurus is also used to link the clients desired output to the normalised description. The system will then present the course to the client as a candidate for inclusion in a client curriculum, as described previously.

Many modifications may be made to the system and the method according to the invention within the scope of the appended claims.

1. A computer-assisted system for the production of training/learning programs (20) for individuals or groups of individuals of an enterprise, with a view to the individuals(s) achieving learning outcomes by implementing learning objects (LO), the system comprising:
a database of normalised LO parameters (14) wherein LO's are described in the framework of a normalised description;
a database of normalised LO outcomes (15) wherein LO outcomes are described in the framework of a normalised description;
a database of learning outcome parameters (18) described in the framework of a normalised description corresponding to that of the normalised LO outcomes (15);
a curricula generation module (F) receiving normalised learning outcome parameters (18) and normalised LO parameters (14), selectable into different combinations thereof for producing a set of alternate learning curricula (19), each curriculum comprising a set of learning objects for the individual(s) to reach a set of outcomes; and
a curriculum selection module (G) receiving curricula (19) from the outcome optimization module (F) and said normalised LO outcomes (15), the curriculum selection module (G) being arranged to provide an interactive indicia of the match to requirements of any given learning curriculum, selectable by choice of LO's corresponding to the normalised LO outcome(s) (15) and learning outcomes corresponding to the learning outcome parameters (18), to assist ranking the curricula for selection of a training/learning plan (20).

2. The system of claim 1 comprising a learning object analysis and description standardisation unit (A,B) which contains a database of LO parameter models and comprises means (10,12) for inputting LO parameters, means for comparing input LO parameters with the LO parameter models, and which is arranged to assist, prompt or effect the conversion of input LO parameters into normalised LO parameters (14) and normalised LO outcomes (15) manually, semi-manually or automatically.

3. The system of claim 1 or 2, comprising an outcome standardisation unit comprising an outcomes thesaurus database (13) associated with an outcome standardisation module (C) having an input for enterprise outcome parameters (16), the outcomes thesaurus database (13) containing a set of normalised outcome names, synonyms and descriptions, the outcome standardisation module (C) being arranged to compare input enterprise outcome parameters (16) with standardised outcomes from the outcomes thesaurus database (13) and being associated with an outcome verification module (D), the modules C and D being arranged to assist, prompt or effect the conversion of input enterprise outcome parameters (16) into standardised/verified enterprise outcome parameters (18).

4. The system of claim 3, wherein the outcome standardisation unit is arranged to:
(a) match input enterprise outcome parameters (16) with normalised outcomes stored in the outcomes thesaurus database (13) when the enterprise outcome parameters are expressed in the same or similar language to stored normalised outcomes; and
(b) when the input enterprise outcome parameters (16) are expressed in words that are different to stored normalised outcomes, convert these words into synonyms thereof that are stored in the outcomes thesaurus database (13), match with normalised outcomes stored in the outcomes thesaurus database (13) and,
(c) then, if there is a failure to match with normalised outcomes stored in the outcomes thesaurus database (13), provide for a verification to complete the outcome standardisation.

5. The system of claim 4, wherein if there is a mismatch of a partly standardised outcome whereof some words are replaced by synonyms, the outcome standardisation unit is arranged for verification that said partly standardised outcome is grammatically and lexically correct to produce a verified outcome proposable as an addition to the outcomes thesaurus database (13).

6. The system of claim 3, 4 or 5, wherein the outcome standardisation unit further comprises a database of standard curricula (17) providing an additional input for the outcome standardisation module (C).

7. The system of any one of claims 3 to 6, wherein the outcomes thesaurus (13) provides input to an LO description normalization module (B) for producing normalised LO outcomes (15).

8. The system of any preceding claim, further comprising means (E) for inputting to the curriculum selection module (G) normalised enterprise parameters (21) that indicate values an enterprise attributes to the normalised LO outcomes (15).

9. The system of any preceding claim, further comprising a monitoring module (H) for comparing parameters contained in a selected plan with updated parameters input by the user as the plan is implemented, and producing progress reports and a new plan if needed.

10. A computer-assisted system for the production of training/learning programs for individuals or groups of individuals of an enterprise, with a view to the individuals(s) achieving learning outcomes by implementing learning objects (LO), the system comprising:
a learning object analysis and description standardisation unit (A,B) which comprises a database of normalised LO parameters (14) including LO parameter models wherein LO's are described in the framework of a normalised description, a database of normalised LO outcomes (15) wherein LO outcomes are described in the framework of a normalised description, means (10,12) for inputting LO parameters, means for comparing input LO parameters with the LO parameter models, and which is arranged to assist, prompt or effect the conversion of input LO parameters into normalised LO parameters (14) and normalised LO outcomes (15) manually, semi-manually or automatically;
an outcome standardisation unit (OS) comprising an outcomes thesaurus database (13) associated with an outcome standardisation module (C) having an input for enterprise outcome parameters (16), the outcomes thesaurus database (13) containing a set of normalised outcome names, synonyms and descriptions, the outcome standardisation module (C) being arranged to compare input enterprise outcome parameters (16) with standardised outcomes from the outcomes thesaurus database (13) and being associated with an outcome verification module (D), the modules C and D being arranged to assist, prompt or effect the conversion of input enterprise outcome parameters (16) into standardised/verified enterprise outcome parameters (18);
an outcome optimization module (F) receiving standardised/verified enterprise outcome parameters (18) from the outcome verification module (D) and normalised LO parameters (14) from the LO unit, selectable manually, semi-manually or automatically into different combinations thereof to produce a set of alternate learning curricula (19); and
a curriculum selection module (G) receiving curricula (19) from the outcome optimization module (F), normalised LO outcomes (15) from the LO unit (A,B), and normalised enterprise parameters (21) that indicate values an enterprise attributes to the normalised LO outcomes (15), said module providing an interactive indicia of the match to requirements of any given learning curriculum, selectable by choice of the normalised LO outcome(s) (15) and the verified enterprise outcome(s) (18) for ranking the curricula to select a training/learning plan.

11. A method for computer-assisted production of a training/learning program for an individual or a group of individuals of an enterprise, with a view to the individuals(s) achieving learning outcomes by implementing learning objects (LO), using the system of any preceding claim, the method comprising:
adding or subtracting learning objects from the normalised LO outcomes (15) and adding or subtracting enterprise outcomes (18) in the curriculum selection module to establish different curricula; ranking the curricula; and selecting a training/learning plan (20).

12. A method of standardizing enterprise outcome parameters using the outcome standardisation unit of a system according to claim 3, or any one of claims 4 to 9 when dependent on claim 3, or claim 10, comprising:
(i) inputting enterprise outcome parameters (16) into the enterprise outcome standardisation module (C);
(ii) matching the input enterprise outcome parameters (16) with normalised outcomes stored in the outcomes thesaurus database (13) when the enterprise outcome parameters are expressed in the same or similar language to stored normalised outcomes;
(iii) when the input enterprise outcome parameters (16) are expressed in words that are different to stored normalised outcomes, converting these words into synonyms thereof that are stored in the outcomes thesaurus database (13), then matching with normalised outcomes stored in the outcomes thesaurus database (13) and
(iv) then, if there is a failure to match with normalised outcomes stored in the outcomes thesaurus database (13), effecting a verification to complete the outcome standardisation.

13. The method of claim 12, wherein if there is a mismatch of a partly standardised outcome whereof some words are replaced by synonyms, said partly standardised outcome is verified to produce a verified outcome which is proposed as an addition to the outcomes thesaurus database (13).

14. A method for computer-assisted production of training/learning programs for individuals or groups of individuals of an enterprise, with a view to the individuals(s) achieving learning outcomes by implementing learning objects (LO), the method comprising:
providing a database of normalised LO parameters (14) wherein LO's are described in the framework of a normalised description, a database of normalised LO outcomes (15) wherein LO outcomes are described in the framework of a normalised description, and a database of learning outcome parameters (18) described in the framework of a normalised description corresponding to that of the normalised LO outcomes (15);
supplying normalised learning outcome parameters (18) and normalised LO parameters (14) to a curricula generation module (F) and selecting different combinations thereof to producing a set of alternate learning curricula (19), each curriculum comprising a set of learning objects for the individual(s) to reach a set of outcomes; and
providing an interactive indicia of the match to requirements of any given learning curriculum by choosing LO's corresponding to the normalised LO outcome(s) (18) and learning outcomes corresponding to the learning outcome parameters (18), ranking the curricula and selecting a training/learning plan (20).

15. A method for computer-assisted production of training/learning programs for individuals or groups of individuals of an enterprise, with a view to the individuals(s) achieving learning outcomes by implementing learning objects (LO), the method comprising:
providing a learning object analysis and description standardisation unit (A,B) which comprises a database of normalised LO parameters (14) wherein LO's are described in the framework of a normalised description, a database of normalised LO outcomes (15) wherein LO outcomes are described in the framework of a normalised description, inputting LO parameters (10,12), comparing input LO parameters with a LO parameter model, and assisting, prompting or effecting the conversion of input LO parameters into normalised LO parameters (14) and normalised LO outcomes (15) manually, semi-manually or automatically;
providing an outcome standardisation unit comprising an outcomes thesaurus database (13) associated with an outcome standardisation module (C) having an input for enterprise outcome parameters (16), the outcomes thesaurus database (13) containing a set of normalised outcome names, synonyms and descriptions, the outcome standardisation module (C) comparing input enterprise outcome parameters (16) with standardised outcomes from the outcomes thesaurus database (13) to provide standardised enterprise outcome parameters, verifying the standardised enterprise outcome parameters, and assisting prompting or effecting the conversion of input enterprise outcome parameters (16) into standardised/verified enterprise outcome parameters (18);
providing an outcome optimization module (F) receiving standardised/verified enterprise outcome parameters (18) from the outcome verification module (D) and normalised LO parameters (14) from the LO unit, and selecting standardised/verified enterprise outcome parameters (18) and normalised LO parameters (14) manually, semi-manually or automatically into different combinations thereof to produce a set of alternate learning curricula (19); and
selecting a training/learning plan by receiving curricula (19) from the outcome optimization module (F), normalised LO outcomes (15) from the LO unit, and normalised enterprise parameters (21) that indicate values an enterprise attributes to the normalised LO outcomes (15), and providing an interactive indicia of the match to requirements of any given learning curriculum by choice of the normalised LO outcome(s) (15) and the verified enterprise outcome(s) (18) to rank the curricula and thereby select a training/learning plan.
